(19) United States
(12) Patent Application Publication
(10) Pub. No.: US 2008/0188139 A1
(43) Pub. Date: Aug. 7, 2008

(54) LOW PROFILE D-SUB CONNECTOR WITH TERMINAL BLOCK TERMINATION

(75) Inventors: Chris Poulin, Carmel, NY (US); Greg Schwartz, Pound Ridge, NY (US)

Correspondence Address: DARBY & DARBY P.C., P.O. BOX 770, Church Street Station, New York, NY, 10008-0770, US

(73) Assignee: BTX Technologies, Inc.

(21) Appl. No.: 11/671,903

(22) Filed: Feb. 6, 2007

(51) Int. Cl. H01R 13/502

(52) U.S. Cl. 439/686

(57) ABSTRACT

The present invention provides a solution to the need in the low voltage electronics industry for a D-subminiature connector system with a rear terminal block termination that allows their use in installation locations that were previously unattainable by using other D-subminiature connectors with rear terminal block termination due to the tight confines of these locations, as well as speedy, accurate and quick assembly of these connectors.

### TECHNICAL FIELD

The present invention relates generally to an electrical connector and more particularly, to D-subminiature connectors with rear terminal block termination for ease of use and a physical profile (footprint) such that it can be used in small spaces where other connectors of this type or similar type are too large.

### BACKGROUND

It is often necessary and desirable to electrically connect one component to another component especially in the ever expanding world of computers and electronics, especially in multi-media applications and settings. A number of different interfaces can be used depending upon the precise nature of the setting.

More specifically, it is often necessary in the low voltage electronic systems integration industry, such as home theater, broadcasting and audio visual, to interconnect many different devices that create a whole system. A large portion of these devices use D-subminiature connectors as the external connection medium. D-subminiature connectors are readily and easily visible in such devices as computer monitors (high density 15 pin d-subminiature), control systems (9 pin standard d-subminiature), video switchers (9 pin standard d-subminiature), audio switchers (25 pin standard d-subminiature) just to name a tiny fraction.

The D-subminiature connectors are typically installed in a wide number of locations and settings, many of which have specific special restraints. For example, the D-subminiature connectors can be installed in custom cabinetry, surface mount electrical boxes, floor pockets and other space-limited locations. Unfortunately, there are a number of deficiencies and limitations that are present when trying to install connectors into these locations that have special constraints. In particular, the size of conventional connectors prohibit their use in many desired environments where space is of a concern.

Consequently, there is a long felt need in the industry to develop a solution to address a) the space-limitations of the installation location and b) the ease of field termination of these connectors since once the devices are installed at the installation location, the device should be easy to terminate in the field.

### SUMMARY

The present invention provides a solution to the need in the low voltage electronics industry for a D-subminiature connector system with a rear terminal block termination that allows their use in installation locations that were previously unattainable by using other D-subminiature connectors with rear terminal block termination due to the tight confines of these locations, as well as speedy, accurate and quick assembly of these connectors.

According to one exemplary embodiment, a connector assembly includes a substrate having a first surface, a front edge, a rear edge, and a pair of side edges extending between the front and rear edges; and a D-subminiature connector mounted to the first surface adjacent the front edge. The assembly further includes a terminal block mounted to the first surface adjacent the rear edge and adjacent the D-subminiature connector. A first depth of the connector, which is a distance from the front edge to the rear edge of the substrate is less than 1 inch.

According to another aspect, a low voltage electronic system includes a connector assembly mounted in an electrical housing. The connector assembly includes a substrate having a first surface, a front edge, a rear edge, and a pair of side edges extending between the front and rear edges; and a D-subminiature connector mounted to the first surface adjacent the front edge, as well as, a terminal block mounted to the first surface adjacent the rear edge and adjacent the D-subminiature connector. The connector assembly has a first depth which is the distance from the front edge to the rear edge of the substrate. The electric housing has an interior into which the connector assembly is mounted. The interior is defined by a second depth that is greater than the first depth. The connector assembly has a third depth which is a distance from the front edge of substrate to the rear face of the D-subminiature connector and this distance is less than 0.40 inch.

In another aspect, the present invention provides a combination of a low-profile electronic connector assembly and an electrical housing. The low-profile connector assembly includes a substrate having a first surface, a front edge, a rear edge, and a pair of side edges extending between the front and rear edges; and a D-subminiature connector mounted to the first surface adjacent the front edge; as well as, a terminal block mounted to the first surface adjacent the rear edge and adjacent the D-subminiature connector. The connector assembly has a first depth equal to the distance from the front edge to the rear edge of the substrate. In addition, the electrical housing has an interior into which the connector assembly is mounted. The interior is defined by a second depth that is greater than the first depth.

Other features and advantages of the present invention will be apparent from the following detailed description when read in conjunction with the accompanying drawings.

### BRIEF DESCRIPTION OF THE DRAWING FIGURES

The foregoing and other features of the present invention will be more readily apparent from the following detailed description and drawings figures of illustrative embodiments of the invention in which:

FIG. 1 is an exploded perspective view of a conventional surface mount electrical box for receiving and housing a connector;

FIG. 2 is a cross-sectional view of a conventional floor electrical box for receiving and housing a connector;

FIG. 3 is a perspective view of a conventional electrical connector;

FIG. 4 is a top plan view of the electrical connector of FIG. 3;

FIG. 5 is a perspective view of an electrical connector according to one exemplary embodiment that includes a low profile D-subminiature connector with a rear terminal block termination; and

FIG. 6 is a top plan view of the connector of FIG. 5.

### DETAILED DESCRIPTION OF PREFERRED EMBODIMENTS

In the low voltage electronics industry, there is a need for a D-subminiature connector system with a rear terminal block termination that allows their use in installation locations that were previously unattainable by using other D-subminiature connectors with rear terminal block termination due to the tight confines of these locations, as well as speedy, accurate and quick assembly of these connectors.

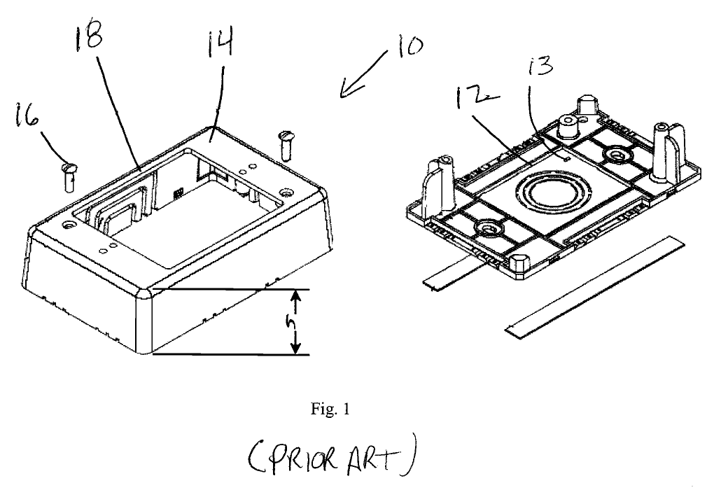

FIG. 1 shows a conventional surface mount electrical box or housing 10 that includes a base 12 and a cover 14 which is attachable to the base 12 with fasteners 16 or the like. The cover 14 has an opening 18 through which a member within the housing 10 can protrude or be accessed. Typically, the depth of the entire unit is less than 1.27 inches since the depth of the cover 14, which is equal to height h of the cover 14, is about 1.27 inches and therefore, when the base 12 which includes a floor 13 is attached to the cover 14, the depth of the overall unit is even less than 1.27 inches (since the floor has some thickness).

The surface mount electrical box 10 is constructed to receive an electrical connector; however, the connector that is mated with the box 10 has to be carefully selected and is limited by the dimensions of the box 10 and in particular, is limited by the depth of the entire unit. The limited space, as measured by the depth, of the box 10 prevents a great number of electrical connector types from being used in combination with the electrical box 10.

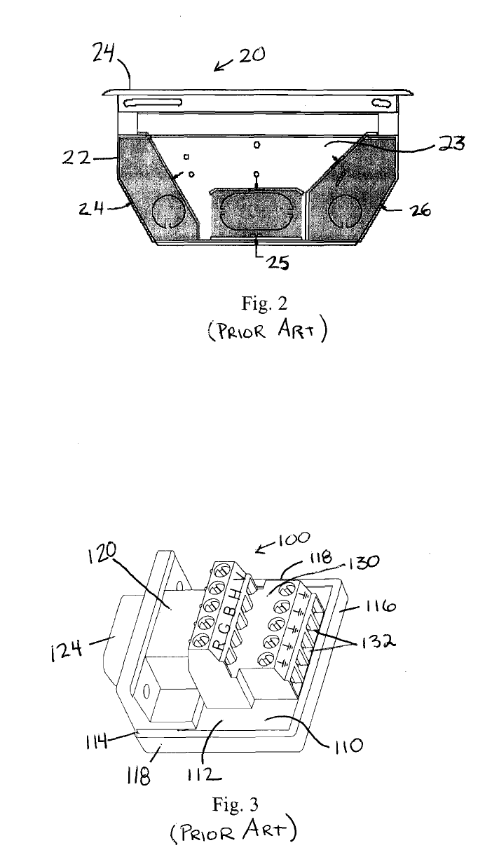

FIG. 2 illustrates a conventional floor electrical box or housing 20 which, similar to the housing 10, is designed to receive an electrical connector. The floor electrical box 20 includes a base 22 and a cover 24 which is attached to the base 22 using some type of fastening means. Within the base 22 is an interior 23 that includes a number of different regions or locations that are constructed to receive an electrical connector. For example, the base 22 can define first, second and third installation locations 24, 25, 26, respectively, that are designed to each receive and hold an electrical connector. However, each of the installation locations 24, 25, 26 has there own associated special constraints and limitations and in particular, the depth of each of the first, second and third installation locations 24, 25, 26 is about 1¼ inch. Consequently and similar to the box 10 of FIG. 1, the limited space, as measured by the depth, of the box 20 prevents a great number of electrical connector types from being used in combination with the electrical box 20.

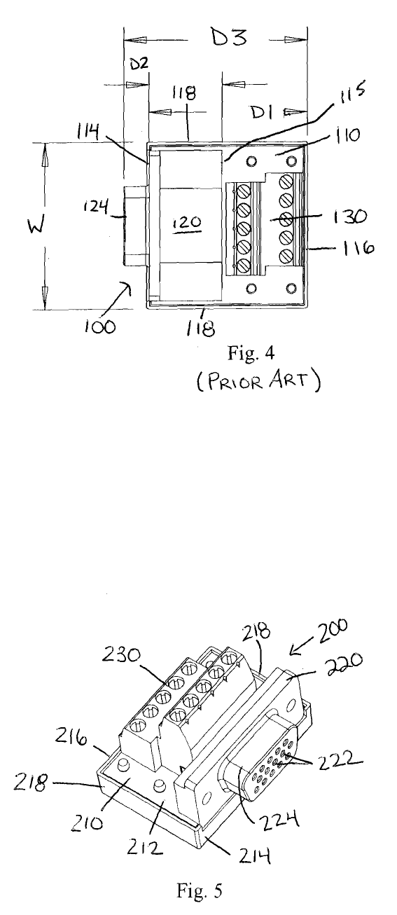

FIGS. 3 and 4 illustrate one type of conventional electrical connector 100 that includes a substrate or base 110 (PC board) onto which a standard D-subminiature connector 120 and a terminal block 130 are attached.

The D-subminiature connector 120 has a conventional design and in particular, the illustrated connector 120 is in the form of a female 90 degree printed circuit mount D-subminiature connector that contains two or more rows of sockets that are surrounded by a D-shaped shield 124 (plastic or metal) that provides screening against electromagnetic interference. The D shape guarantees correct orientation. It will be understood that the nomenclature “D-subminiature” is a connector system and it defines a range of connectors with varying numbers of poles (contacts) and further, there is most often, a “shell size” nomenclature that is associated with D-subminiature connectors and in particular, with the dimensions of the shield 124.

With such parts, a D is used as the prefix for the whole series, followed by a letter denoting the shell size (A=15 pin, B=25 pin, C=37 pin, D=50 pin; E=9 pin), followed by the actual number of pins, followed by the gender (M=male, F=female). Further, D-subminiature connectors also come in standard and high density. For instance, a 9 pin D-sub and a high density 15 pin D-sub both utilize the “E” shell size. Therefore, anywhere a 9 pin D-sub can be placed, a high density 15 pin D-sub can likewise be used. The connector 100 illustrated in FIGS. 3 and 4 is of a 15 pin D-sub variety.

The terminal block 130 has a conventional design in that includes a number of openings (terminals) 132 that receive and retain wires or the like that are then electrically connected to the contacts of the D-subminiature connector 100 by means of a conductive pattern (leads) that provide an electrical pathway between each pin of the D-subminiature connector 100 and the conductive wire or the like that is inserted and retained within one terminal 132 of the block 130.

The substrate 110 includes a floor 112 to which the D-subminiature connector 120 and terminal block 130 are attached and typically, the substrate 110 has either a rectangular or square shape that is defined by a front edge 114, an opposing rear edge 116 and a pair of side edges 118 that extend therebetween. The standard connector 100 has the following dimensions which are indicated in FIG. 4. The width (w) of the connector 100 as measured from the one side edge 118 to the other side edge 118 is about 1.34 inch, while the depth (D₁) of the portion of the connector 100 that will reside behind the panel, plate or box (e.g., boxes 10 and 20) in which the connector 100 is mounted is about 1.36 inch. This portion of the connector 100 is measured from the front edge 114 to the rear edge 116 of the substrate 110. In addition, the measurement D₂ reflects the depth of the D-subminiature connector 120 from edge 114 to a rear face 115 of the D-subminiature connector 120. In the illustrated embodiment, the distance D₂ is about 0.64 inch and the depth (D₃) of the entire connector 100 is about 1.57 inch.

A portion of the connector 100 will protrude though the front of the panel, plate or box that it is mounted in. For example, a portion of the connector 100 will protrude through the opening 18 the cover 14 of the box 10. In the illustrated embodiment, this portion of the connector 100 protrudes about 0.21 inch from the front of the panel, plate or box as measured by the distance from the front edge 114 to a front edge 124 of the D-subminiature connector 120. This distance is equal to (D₃) minus (D₁).

Based on the aforementioned dimensions, one will appreciate that the connector 100 is too long in the “behind the panel” dimension (D₁)(distance from front edge 114 to rear edge 116) to be used in traditional installation locations, including, the box 10 and the box 20. This is because the box 10 has a depth at best of 1.27 inch and the box 20 has a depth at least of 1.25 inch, both of which are less than the behind the panel depth of the connector 100, namely, 1.36 inch. As a result, the connector 100 cannot be used in such installation locations and this forecloses using connectors of the type shown in FIGS. 3 and 4 with electrical panels, plates and boxes, such as the ones shown in FIGS. 1 and 2.

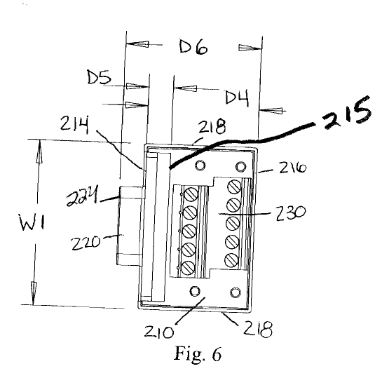

Now turning to FIGS. 5 and 6, an electrical connector 200 according to one exemplary embodiment of the present invention is illustrated. The electrical connector 200 is designed so that it has a low-profile that permits it to be used in installation locations that were previously not possible due to the excessive size of previous connectors, such as connector 100. The electrical connector 200 includes a substrate or base 210 onto which a D-subminiature connector 220 and a terminal block 230 are attached.

The D-subminiature connector 220 is of a low-profile design and includes contains two or more rows of sockets 222 that are surrounded by a D-shaped shield 224 (plastic or metal) that provides screening against electromagnetic interference; however, the body or housing of the D-subminiature connector 220 is of a low-profile design and therefore, the body thereof has reduced dimensions as described below.

The terminal block 230 includes a number of openings (terminals) that receive and retain wires or the like that are then electrically connected to the contacts of the D-subminiature connector 200 by means of a conductive pattern (leads) that provide an electrical pathway between each pin of the D-subminiature connector 200 and the conductive wire or the like that is inserted and retained within one terminal of the block 230.

The substrate 210 includes a floor 212 to which the D-subminiature connector 220 and terminal block 230 are attached and typically, the substrate 210 has either a rectangular or square shape that is defined by a front edge 214, an opposing rear edge 216 and a pair of side edges 218 that extend therebetween. The connector 200 of the present invention has the following dimensions which are indicated in FIG. 6. The width (w₁) of the connector 200 as measured from the one side edge 218 to the other side edge 218 is about 1.34 inch, while the depth (D₄) of the portion of the connector 200 that will reside behind the panel, plate or box (e.g., boxes 10 and 20) in which the connector 200 is mounted is about 0.93 inch. It will be appreciated that this distance (depth) (0.93 inch) is significantly less than the previous design which had a depth (D₁) of about 1.36 inch, thereby permitting the connector 200 to be used in a greater number of applications. This behind the panel portion of the connector 200 is measured from the front edge 214 to the rear edge 216 of the substrate 210.

In addition, the measurement D₅ reflects the depth of the D-subminiature connector 220 from edge 214 to a rear face 215 of the D-subminiature connector 220. In the illustrated embodiment, the distance D₅ is about 0.21 inch and the depth (D₆) of the entire connector 100 is about 1.14 inch.

A portion of the connector 200 will protrude though the front of the panel, plate or box that it is mounted in. For example, a portion of the connector 200 will protrude through the opening 18 the cover 14 of the box 10. In the illustrated embodiment, this portion of the connector 200 protrudes about 0.21 inch from the front of the panel, plate or box as measured by the distance from the front edge 214 to a front edge 224 of the D-subminiature connector 220. This distance is equal to (D₆) minus (D₄).

Accordingly, the depth (D₆) of the entire connector 200 is about 1.14 inch which is equal to the depth behind the panel, plate or box (0.93 inch) plus the distance the connector protrudes therefrom (0.21 inch).

Based on the construction and dimensions of the connector 200, the connector 200 offers an electrical connector assembly that can be used with mounting panels, plates or boxes that were otherwise not possible. For example, the connector 200 can easily be received into and contained within the electrical box 10 and the electrical box 20 since the behind the panel depth of the connector 200 is well within the limits that are suitable for the box 10 and box 20.

It will be appreciated that the depth of the D-subminiature connector 220 from the front face or edge 224 to the rear face 215, which is before the terminal block 230, is substantially less in the present invention compared to conventional design due to the incorporation of the low-profile D-subminiature connector 220 with the other components. In conventional design, this distance (D₂) is about 0.64 inch, while in the present invention, this distance (D₅) is about 0.21 inch. This provides a number of advantages to such a connector assembly.

Thus, the connector 200 according to the present invention can be used in surface mount electrical boxes (box 10) and floor electrical boxes (box 20) to name just a few of the suitable applications.

It will also be appreciated that the connector 200 is not limited to being a 15 pin design but instead, the connector 200 can be any number of different types of connectors. More particularly, the depth and height of the connector 200 is uniform and would not change depending on what type (number of pins and standard or high density type) of the connector 200 is being used. For example, a 9 pin standard D-subminiature connector and a high density 15 pin D-subminiature connector are the same size and have a first width; a 15 pin standard D-subminiature connector and a high density 26 pin D-subminiature connector are the same size and have a second width that is greater than the first width; and a 25 pin standard D-subminiature connector and a high density 44 pin D-subminiature connector are the same size and have a third width that is greater than the second width. The connector 200 according to the present invention can be any of the aforementioned types of D-subminiature connectors and therefore, can be used in combination with any of the electrical components discussed here and in particular, the boxes 10 and 20 to name a few.

It will be appreciated by persons skilled in the art that the present invention is not limited to the embodiments described thus far with reference to the accompanying drawings; rather the present invention is limited only by the following claims.

What is claimed is:

1. A connector assembly comprising:
a substrate having a first surface, a front edge, a rear edge, and a pair of side edges extending between the front and rear edges;
a D-subminiature connector mounted to the first surface adjacent the front edge; and
a terminal block mounted to the first surface adjacent the rear edge and adjacent the D-subminiature connector;
wherein a first depth of the connector, which is a distance from the front edge to the rear edge of the substrate is less than 1 inch.

2. The connector assembly of claim 1, wherein the width of the substrate is about 1.34 inch and the first depth is about 0.93 inch.

3. The connector assembly of claim 1, wherein the first depth is less than 0.95 inch.

4. A connector assembly comprising:
a substrate having a first surface, a front edge, a rear edge, and a pair of side edges extending between the front and rear edges;
a D-subminiature connector mounted to the first surface adjacent the front edge, the D-subminiature connector having a front face and a rear face, the front face extending beyond the front edge of the substrate; and
a terminal block mounted to the first surface adjacent the rear edge and adjacent but spaced from the rear face of the D-subminiature connector;
wherein a first depth of the connector assembly, which is a distance from the front edge of substrate to the rear face of the D-subminiature connector is less than 0.40 inch.

5. The assembly of claim 4, wherein the first depth is less than 0.33 inch.

6. The assembly of claim 4, wherein the first depth is equal to or less than 0.21 inch.

7. The assembly of claim 4, wherein the connector assembly includes a second depth which is the distance from the front edge to the rear edge of the substrate and is less than 1.00 inch.

8. The assembly of claim 4, wherein a depth of a portion of the D-subminiature connector that extends beyond the first edge is substantially equal to a depth of a portion of the D-subminiature connector that extends inwardly from the front edge toward the rear edge.

9. A low voltage electronic system comprising:
a connector assembly including:
a substrate having a first surface, a front edge, a rear edge, and a pair of side edges extending between the front and rear edges;
a D-subminiature connector mounted to the first surface adjacent the front edge; and
a terminal block mounted to the first surface adjacent the rear edge and adjacent the D-subminiature connector;
wherein the connector assembly has a first depth which is a distance from the front edge to the rear edge of the substrate and is less than 1.00 inch; and
an electric housing having an interior into which the connector assembly is mounted, the interior being defined by a second depth that is greater than the first depth.

10. The system of claim 9, wherein the second depth is less than 1.30 inch.

11. The system of claim 9, wherein the second depth is between 1.20 inch and 1.27 inch.

12. The system of claim 9, wherein the electrical housing comprises a surface mount electrical box that has a cover that is attached to a base, the substrate seating against the floor.

13. The system of claim 9, wherein the electrical housing comprises a floor electrical box including a base into which the connector is received and a cover.

14. The system of claim 9, wherein the system is in the form of a home theater system and the connector connects one electronic device to another electronic device, the electrical housing being incorporated into a panel of the home theater system.

15. A combination of a low-profile electronic connector assembly and an electrical housing, the low-profile connector assembly having:
a substrate having a first surface, a front edge, a rear edge, and a pair of side edges extending between the front and rear edges;
a D-subminiature connector mounted to the first surface adjacent the front edge; and
a terminal block mounted to the first surface adjacent the rear edge and adjacent the D-subminiature connector;
wherein the connector assembly has a first depth equal to the distance from the front edge to the rear edge of the substrate which is less than 1.00 inch; and
wherein the electrical housing has an interior into which the connector assembly is mounted, the interior being defined by a second depth that is greater than the first depth so that the front and rear edges of the substrate are fully contained in the electrical housing.

16. The combination of claim 15, wherein a width of connector assembly, which is a distance between the side edges, is greater than a first depth of the connector.

17. The combination of claim 15, wherein the second depth is at least 25% greater than the first depth.

18. The combination of claim 15, wherein the second depth is at least 32% greater than the first depth.

19. The combination of claim 15, wherein the D-subminiature connector has a front face and a rear face, the front face extending beyond the front edge of the substrate and second face facing but being spaced from one end of the terminal block and wherein a third depth of the connector assembly, which is a distance from the front edge of substrate to the rear face of the D-subminiature connector is less than 0.40 inch.
